(19) United States
(12) Patent Application Publication
(10) Pub. No.: US 2005/0164646 A1
(43) Pub. Date: Jul. 28, 2005

(54) Outer loop power control using multiple channels

(75) Inventors: Wanshi Chen, San Diego, CA (US); Alpaslan Gence Savas, San Diego, CA (US); Shiau-He Shawn Tsai, San Diego, CA (US); Tao Wu, Carlsbad, CA (US)

Correspondence Address: COATS & BENNETT, PLLC, P O BOX 5, RALEIGH, NC, 27602, US

(73) Assignee: Telefonaktiebolaget LM Ericsson

(21) Appl. No.: 11/020,706

(22) Filed: Dec. 23, 2004

Related U.S. Application Data
(60) Provisional application No. 60/540,114, filed on Jan. 28, 2004.

(51) Int. Cl. H04Q 7/20

(52) U.S. Cl. 455/69; 455/522

(57) ABSTRACT

Outer loop power control (OLPC) for the reverse link considers frame information associated with at least two reverse link traffic channels, the transmit power of which is referenced to the transmit power of a reverse link pilot channel R-PICH. A traffic OLPC setpoint is determined based on information such as target frame error rate (FER) and actual frame errors associated with each traffic channel, and the traffic OLPC setpoint is converted to a R-PICH OLPC setpoint. The traffic OLPC setpoint may be calculated from weighted frame information generated by combining the received frame information. Alternatively, a traffic channel OLPC setpoint may be determined for each channel, and a weighted traffic OLPC setpoint calculated from the individual traffic channel OLPC setpoint. The setpoint adjustment may depend on received frame errors, where the power up step size is a multiple of the power down step size, the multiple calculated from target FERs.

### RELATED APPLICATIONS

This application claims priority to Provisional U.S. Patent Application 60/540,114 filed Jan. 28, 2004, which is incorporated herein by reference.

### BACKGROUND

The present invention relates generally to wireless communication systems, and in particular to system and method of outer loop power control for a plurality of traffic channels, the power of each of which is referenced to a common pilot channel.

Most wireless communication networks employ some form of power control, whereby controllers within the network (e.g., radio base stations) command mobile stations to increase or decrease their transmit power. Mobile stations closer to a base station antenna may transmit signals at a lower power level than those distant from the antenna, to achieve the same received signal strength. In wireless systems employing frequency reuse, power control reduces interference in neighboring cells using the same frequency. In spread-spectrum wireless systems, which are interference limited, power control is critical to support a large number of simultaneous users. In all cases, effective power control preserves mobile station battery life.

In wireless networks complying with the cdma2000 standard, power control is necessary to maintain the quality of a wide range of services, such as voice, data, images, video, interactive applications and the like. Typically, closed loop power control attempts to maintain a desired Frame Error Rate (FER). This is achieved by two different closed control loops: an inner loop power control and an outer loop power control. The inner loop power control adjusts the mobile station transmit power to track a desired setpoint—or received power level above noise—by sending power up and down commands. The outer loop power control adjusts the required setpoint to maintain the desired FER for traffic channels. In other words, the outer loop power control sets a target, and the inner loop power control adjusts the power to conform to the target.

In the cdma2000 forward link, when multiple channels co-exist, e.g., forward fundamental channel (F-FCH) and forward supplemental channel (F-SCH), the inner loop and outer loop power control for each channel is independent. That is, the power and setpoint adjustments for F-FCH are not associated with those for F-SCH.

However, in the cdma2000 reverse link, the inner loop power control is achieved via the dynamic power adjustment of the reverse pilot channel (R-PICH). All other channels, such as reverse fundamental channel (R-FCH), reverse supplemental channel (R-SCH), reverse packet data channel (R-PDCH), and the like, transmit at power levels held relatively fixed against that of R-PICH. That is, there is a single inner loop power control for all the channels. This makes it difficult to maintain the target FER in each channel, due to different channel conditions and characteristics (e.g., burstiness). The gain for each dedicated channel, relative to the R-PICH, is configurable via layer 3 signaling messages. However, this is an inefficient control mechanism, and cannot respond rapidly to transient conditions.

### SUMMARY

The present invention relates to a method of power control in a wireless communication system. Signal reception information associated with each of a plurality of wireless traffic channels, the transmit power of which is referenced to a pilot channel, is obtained. A pilot channel outer loop power control (OLPC) setpoint is determined based on signal reception information related to at least two of the wireless traffic channels.

The present invention also relates to a wireless communication system. The system includes at least one mobile station transmitting a reverse link pilot channel and at least two reverse link traffic channels, where the transmit power of each traffic channel is referenced to the pilot channel. The communication system also includes a base station sending power control commands to the mobile station, the power control commands based on received frame information associated with at least two of the reverse link traffic channels.

### BRIEF DESCRIPTION OF DRAWINGS

FIG. 1 is a functional block diagram of a wireless communication system.

FIG. 2 is a block diagram of a prior art method of determining an outer loop power control setpoint for reverse channels.

FIG. 3 is a block diagram of a method of determining an outer loop power control setpoint for reverse channels based on received frame information for two or more reverse link channels.

FIG. 4 is a block diagram of a method of determining an outer loop power control setpoint for reverse channels by combining frame information to determine a traffic setpoint.

FIG. 5 is a block diagram of a method of determining an outer loop power control setpoint for reverse channels by calculating a traffic channel setpoint for each channel, and combining the traffic channel setpoints to determine a weighted traffic setpoint.

### DETAILED DESCRIPTION

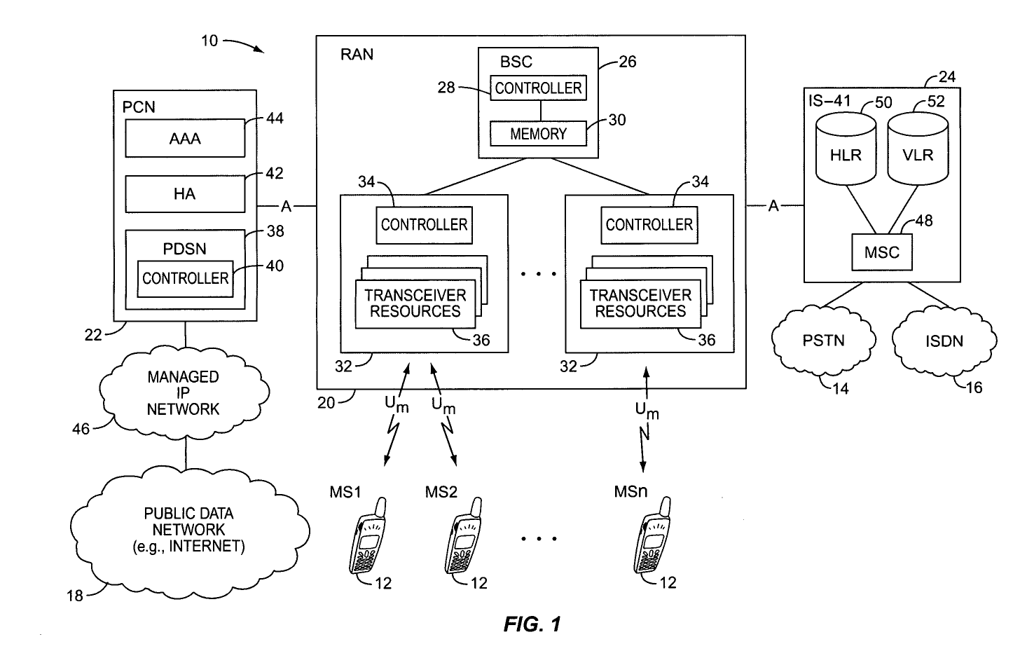

FIG. 1 illustrates an exemplary wireless communication network generally referred to by the numeral 10. In an exemplary embodiment, network 10 is based on cdma2000, 1xEV-DO/DV standards as promulgated by the Telecommunications Industry Association (TIA), although the present invention is not limited to such implementations. Here, network 10 communicatively couples one or more mobile stations (MSs) 12 to the Public Switched Telephone Network (PSTN) 14, the Integrated Data Services Network (ISDN) 16, and/or a Public Data Network (PDN) 18, such as the Internet. In support of this functionality, the network 10 comprises a Radio Access Network (RAN) 20 connected to a Packet Core Network (PCN) 22 and an IS-41 network 24.

The RAN 20 typically comprises one or more Base Station Controllers (BSCs) 26, each including one or more controllers 28 or other processing systems, with associated memory 30 for storing necessary data and parameters relating to ongoing communications activity. Generally, each BSC 26 is associated with one or more Base Stations (BSs) 32. Each BS 32 comprises one or more controllers 34, or other processing systems, and assorted transceiver resources 36 supporting radio communication with MSs 12, such as modulators/demodulators, baseband processors, radio frequency (RF) power amplifiers, antennas, etc.

BSs 32 may be referred to as Base Transceiver Systems (BTSs) or Radio Base Stations (RBSs). In operation, BSs 32 transmit control and traffic data to MSs 12 on forward link channels, and receive control and traffic data from them over on reverse link channels. The BSs 32 may perform power control on the MSs 12. BSC 26 provides coordinated control of the various BSs 32. The BSC 26 also communicatively couples the RAN 20 to the PCN 22.

The PCN 22 comprises a Packet Data Serving Node (PDSN) 38 that includes one or more controllers 40, or other processing systems, a Home Agent (HA) 42, and an Authentication, Authorization, and Accounting (AAA) server 44. Typically, the PCN 22 couples to the PDN 18 through a managed IP network 46, which operates under the control of the network 10. The PDSN 38 operates as a connection point between the RAN 16 and the PDN 18 by establishing, maintaining and terminating Point-to-Point Protocol (PPP) links, and further provides Foreign Agent (FA) functionality for registration and service of network visitors. HA 42 operates in conjunction with PDSN 38 to authenticate Mobile IP registrations and to maintain current location information in support of packet tunneling and other traffic redirection activities. Finally, AAA server 44 provides support for user authentication and authorization, as well as accounting services.

The BSC 26 also communicatively couples the RAN 20 to the IS-41 network 24. The IS-41 network 24 includes a Mobile Switching Center (MSC) 48 accessing a Home Location Register (HLR) 50 and Visitor Location Register (VLR) 52 for subscriber location and profile information. The MSC 48 establishes circuit-switched and packet-switched communications between the RAN 20 and the PSTN 16 and ISDN 16.

Conventional outer loop power control is designed to target the Frame Error Rate (FER) for one of the dedicated channels, such as the reverse fundamental channel R-FCH. To achieve the target FER for other dedicated channels (such as R-SCH, R-PDCH, and the like), the BS 32 must rely on the correct setting of relative gains of those channels to the reverse pilot channel R-PICH. Due to the nature of radio channel conditions, the optimal relative gains are dynamic and different from one MS 12 to another. The adjustment of the relative gains can be achieved via relatively infrequent layer 3 signaling messages.

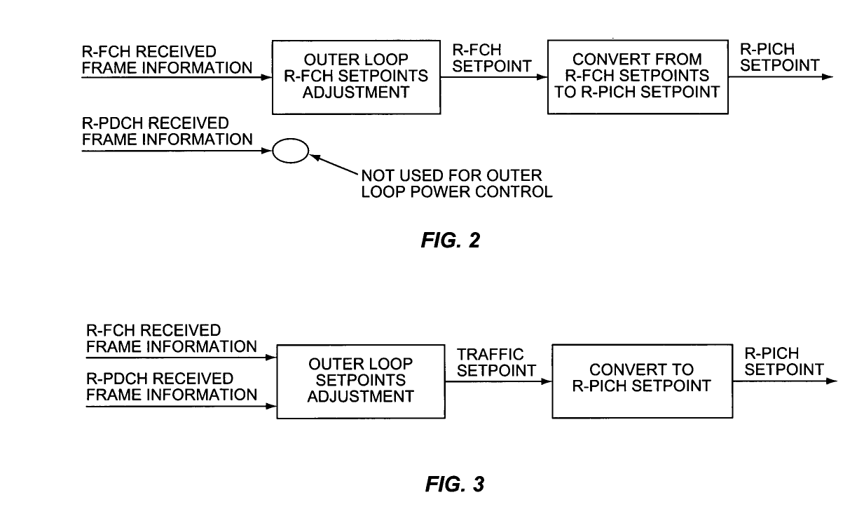

This situation is depicted in FIG. 2. Frame information associated with the R-FCH (such as FER) is received, and an outer loop R-FCH setpoint is adjusted to maintain a desired FER. In general, if the received frame is a good frame, the setpoint is decreased by the step size Step_{d}. When the received frame is a bad frame, the setpoint is increased by the step size Stepᵤ. In order to maintain the target FER, the relationship between Step_{d} and Stepᵤ typically satisfies the relationship:

$$\frac{{Step}_{u}}{{Step}_{d}} = \frac{1}{targetFER} - 1 \qquad ( 1 )$$

The R-FCH setpoint is then converted to an R-PICH setpoint, and the R-PICH setpoint is used to adjust the power of the R-PICH. The power of the R-FCH is indirectly adjusted according to the gain of the R-FCH relative to the R-PICH.

However, that frame information associated with other active reverse dedicated channels, such as the reverse packet data channel R-PDCH, is not used at all for power control. The only way to adjust power for R-PDCH is to change the channel's gain relative to the R-PICH via layer 3 signaling.

According to one embodiment of the present invention, frame information from at least two dedicated reverse channels is utilized to generate a reverse channel outer loop power control setpoint, as depicted in FIG. 3. In FIG. 3, frame information from both the R-FCH and R-PDCH are combined to adjust a traffic setpoint. This traffic setpoint is then converted to an R-PICH setpoint, and the power of the R-PICH is adjusted. The traffic setpoint adjustment may consider the target FER requirements of the different channels, the relative importance of the channels, and other factors. In general, those of skill in the art will recognize that the different reverse channel frame information may be combined in a variety of ways.

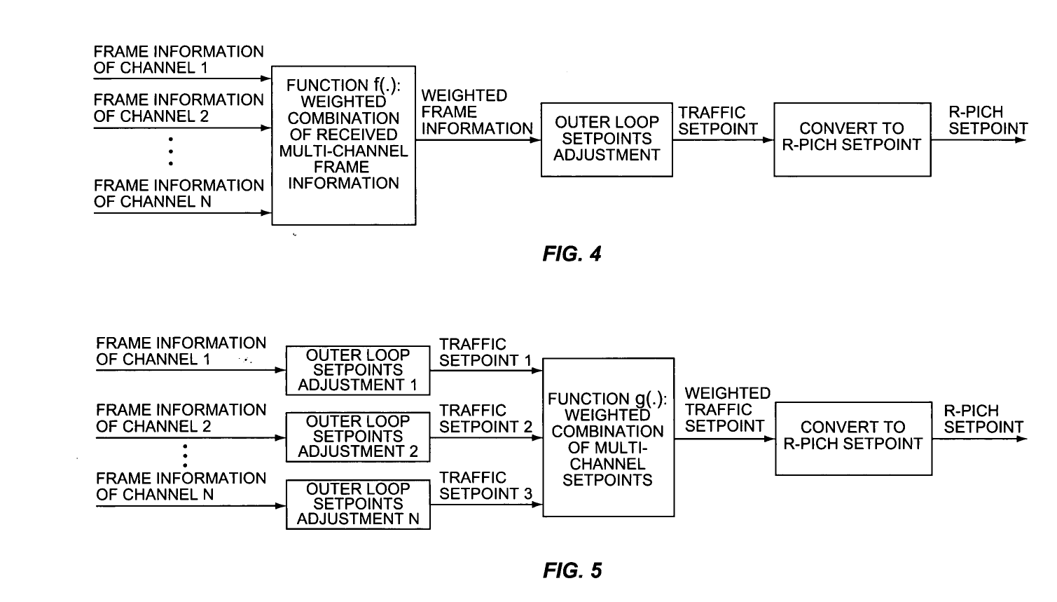

One embodiment of the present invention is depicted in FIG. 4. Received frame information associated with all active, reverse, dedicated channel are combined through a function f(.). As discussed above, f(.) may depend on the target FER for each channel, the relative importance of each channel, the “burstiness” or other characteristics of the channel, and the like. In general, the more important the channel, the larger its weight in the calculation. The function f(.) may be linear or non-linear. As one example, f(.) may include an array of coefficients C=[c(1), c(2), . . . , c(N)], such that the disparate frame information is combined as:

$$\begin{matrix}Weighted Frame \\ Information\end{matrix} = {\sum }_{n = 1}^{N} c ( n ) * Frame Information for Channel n \qquad ( 2 )$$

The weighted frame information then adjusts a multi-channel traffic setpoint, which is converted to a setpoint for the P-PICH. Transmit power for each of the N reverse link traffic channels is then adjusted according to each channel's gain relative to P-PICH. Note that some of the traffic channels may be bursty in nature, and thus exhibit discontinuous transmissions. If those channels are discontinued (DTX-ed), they should be excluded from equation (2). In other words, the number of reverse link traffic channels, N, may be dynamic on a per frame basis.

Another embodiment of the present invention is depicted in FIG. 5. The outer loop power control is performed independently for each channel, based on frame information for the channel such as FER. The multiple channel setpoints are then combined by a weighting function g(.), which may consider the relative importance of the channels, and/or other factors. The function g(.) may be linear or non-linear. As one example, the function includes an array of coefficients D=[d(1), d(2), . . . , d(N)], such that the setpoints are combined as:

$$Weighted Traffic Setpoint = {\sum }_{n = 1}^{N} d ( n ) * Traffic Setpoint of Channel n \qquad ( 3 )$$

The weighted traffic setpoint is then converted to a setpoint for the P-PICH. Transmit power for the N reverse link traffic channels is then adjusted according to each channel's gain relative to P-PICH. As noted above, some of the traffic channels may be bursty in nature, and thus exhibit discontinuous transmissions. If those channels are discontinued (DTX-ed), the discontinued channels should be excluded from equation (3). That is, the number of reverse link traffic channels, N, may be dynamic on a per frame basis.

Regardless of the method by which the desired setpoint is calculated, the setpoint is adjusted by issuing power up and down commands comprising step sizes Stepᵤ and Step_{d} to increase or decrease the power, respectively. When multiple channels are considered in setpoint adjustment, the step sizes Stepᵤ and Step_{d} may depend on the number of channels, the target FER of each channel, and other factors.

Over a time duration of N frames, the goal is to maintain a target FER given by equations (2) or (3), in the case that frame information in those equations comprises FER. For example, a 2% sum target FER would translate to two frame erasures in 100 frames. For two simultaneous channels, the two frame erasures may occur twice on one channel with no bad frames on the other channel, or alternatively may occur once on each of the two channels. In the latter case, the frame erasures may occur at separate times, or may occur simultaneously. The latter of these cases—simultaneous frame erasures—calls for a greater adjustment to the power control setpoint than does the case where frame errors are received separately, i.e., where a good frame was received along with each bad frame.

In one embodiment of the present invention, when only good frames are received on all channels, the setpoint is decreased by Step_{d}. If one bad frame is received, the setpoint is increased by Stepᵤ₁ given by the equation:
Stepᵤ₁=Step_{d}*(1−SumTargetFER)/SumTargetFER (4)
where SumTargetFER is the weighted sum of the FER requirements of each individual traffic channel, in a similar fashion as in equation (2) or (3), that is:

$$SumTargetFER = {\sum }_{n = 1}^{N} c ( n ) * TargetFER for each Traffic Channel \qquad ( 5 )$$

If two channels are transmitting and two frame erasures are received simultaneously, the setpoint is increased by Stepᵤ₂, given by the equation:
Stepᵤ₂=Step_{d}*(1−MeanTargetFER)/MeanTargetFER (6)
where MeanTargetFER=SumTargetFER/N, and
N=the number of active channels.

For example, if the R-FCH and R-PDCH transmit simultaneously, and the target FER for each channel is 1%, then the SumTargetFER is 2% and the MeanTargetFER is 1%. This will yield Stepᵤ₁=49*Step_{d}, and Stepᵤ₂=99*Step_{d}. On the other hand, if only the R-FCH is transmitting over a given period, and the target FER for the P-FCH is 1%, then SumTargetFER is 1% and Stepᵤ₁=99*Step_{d}. Thus, the setpoint correction for one error on one operative channel is the same as the case of two errors on two channels (or N simultaneous errors on N channels). The step up size only changes in the case of a smaller number of simultaneous errors than the number of simultaneous channels (i.e., when at least some good frames were received).

The outer loop power control of the present invention improves power control performance in the presence of multiple channels by considering frame information associated with multiple channels. The power control of the present invention is effective in maintaining the target FER for each of the multiple channels, and reduces the need to adjust the relative gains of the dedicated channels to the R-PICH via layer 3 signaling.

Although the present invention has been described herein with respect to particular features, aspects and embodiments thereof, it will be apparent that numerous variations, modifications, and other embodiments are possible within the broad scope of the present invention, and accordingly, all variations, modifications and embodiments are to be regarded as being within the scope of the invention. The present embodiments are therefore to be construed in all aspects as illustrative and not restrictive and all changes coming within the meaning and equivalency range of the appended claims are intended to be embraced therein.

1. A method of power control in a wireless communication system, comprising:
obtaining received frame information associated with each of a plurality of reverse link traffic channels, the transmit power of which is referenced to a reverse link pilot channel; and
determining a reverse link pilot channel outer loop power control setpoint based on frame information related to at least two said reverse link traffic channels.

2. The method of claim 1 wherein determining said reverse link pilot channel outer loop power control setpoint comprises:
determining a traffic outer loop power control setpoint based on frame information related to at least two said reverse link traffic channels; and
converting said traffic outer loop power control setpoint to said reverse link pilot channel outer loop power control setpoint.

3. The method of claim 2 wherein determining a traffic outer loop power control setpoint comprises:
determining weighted frame information based on frame information related to at least two said reverse link traffic channels; and
determining said traffic outer loop power control setpoint based on said weighted frame information.

4. The method of claim 3 wherein determining weighted frame information comprises summing, over said at least two reverse link traffic channels, the product of frame information related to each said reverse link traffic channel and a weighting factor associated with each said reverse link traffic channel.

5. The method of claim 4 wherein each said weighting factor is related to the importance of each associated reverse link traffic channel.

6. The method of claim 2 wherein determining a traffic outer loop power control setpoint based on frame information related to at least two said reverse link traffic channels comprises:
determining a traffic channel outer loop power control setpoint associated with each said reverse link traffic channel; and
determining a weighted traffic outer loop power control setpoint based on said traffic channel outer loop power control setpoints;

7. The method of claim 6 wherein determining said weighted traffic outer loop power control setpoint comprises summing, over said reverse link traffic channels, the product of said traffic channel outer loop power control setpoint and a weighting factor associated with each said reverse link traffic channel.

8. The method of claim 7 wherein each said weighting factor is related to the importance of each associated reverse link traffic channel.

9. The method of claim 1 wherein said frame information includes frame error information;

10. The method of claim 9 wherein determining a reverse link pilot channel outer loop power control setpoint comprises:
determining a target frame error rate (FER) for each said reverse link traffic channel;
determining a down step size Step_{d};
calculating an up step size Stepᵤ in response to the target FERs of said reverse link traffic channels;
decreasing a previously determined reverse link pilot channel outer loop power control setpoint by Step_{d} if no said reverse link traffic channel experiences an error over a preceding frame; and
increasing said previously determined reverse link pilot channel outer loop power control setpoint by Stepᵤ if at least one said reverse link traffic channel experiences an error over the preceding frame.

11. The method of claim 10 wherein Stepᵤ is a multiple of Step_{d}.

12. The method of claim 11 wherein said multiple of Step_{d} depends on the number of said reverse link traffic channels experiencing an error over the preceding frame.

13. The method of claim 12 wherein if one frame error is encountered, Stepᵤ is given by
Stepᵤ=Step_{d}*(1−SumTargetFER)/SumTargetFER
where SumTargetFER is the weighted FERs for each said reverse link traffic channel.

14. The method of claim 12 wherein if multiple frame errors are encountered, Stepᵤ is given by
Stepᵤ₂=Step_{d}*(1−MeanTargetFER)/MeanTargetFER
where MeanTargetFER=SumTargetFER/N and N is the number of channels.

15. The method of claim 1 further comprising sending power up or power down commands to a mobile station transmitting a reverse link pilot channel and a plurality of reverse link traffic channels, to adjust the transmit power of said reverse link pilot channel to said reverse link pilot channel outer loop power control setpoint.

16. A wireless communication system, comprising:
at least one mobile station transmitting a reverse link pilot channel and at least two reverse link traffic channels, the transmit power of each said traffic channel referenced to said pilot channel; and
a base station sending power control commands to said mobile station, said power control commands based on received frame information associated with at least two said reverse link traffic channels.

17. The system of claim 15 wherein said base station calculates a traffic outer loop power control setpoint based on received frame information associated with at least two said reverse link traffic channels, converts said traffic setpoint to a reverse link pilot channel outer loop power control setpoint, and sends said power control commands to adjust said reverse link pilot channel transmit power to said reverse link pilot channel outer loop power control setpoint.

18. The system of claim 16 wherein said base station calculates a weighted combination of frame information based on received frame information associated with at least two said reverse link traffic channels, and determines said traffic outer loop power control setpoint based on said weighted combination of frame information.

19. The system of claim 16 wherein said base station calculates a traffic channel outer loop power control setpoint for each said reverse link traffic channel, and determines a weighted traffic outer loop power control setpoint based on at least two said traffic channel outer loop power control setpoints.

20. The system of claim 16 wherein said power control commands adjust the transmit power of said reverse link pilot channel based on target frame error rates (FER) and received frame information associated at least two said reverse link traffic channels.

21. The system of claim 20 wherein said power control commands decrease the transmit power of said reverse link pilot channel by a predetermined step size Step_{d} if no said reverse link traffic channel experiences an error over a preceding frame, and increase said transmit power by step size Stepᵤ that is a multiple of Step_{d} in response to receiving at least one frame error on at least one said traffic channel.

22. The system of claim 21 wherein if one frame error is encountered, Stepᵤ is given by
Stepᵤ=Step_{d}*(1−SumTargetFER)/SumTargetFER
where SumTargetFER is the weighted FERs for each said reverse link traffic channel.

23. The system of claim 21 wherein if multiple frame errors are encountered, Stepᵤ is given by
Stepᵤ₂=Step_{d}*(1−MeanTargetFER)/MeanTargetFER
where MeanTargetFER=SumTargetFER/N and N is the number of channels.
